(19) United States
(12) Patent Application Publication
(10) Pub. No.: US 2025/0390146 A1
(43) Pub. Date: Dec. 25, 2025

(54) COVER WINDOW FOR DISPLAY DEVICE AND METHOD OF MANUFACTURING COVER WINDOW FOR DISPLAY DEVICE

(71) Applicant: Samsung Display Co., Ltd., Yongin-si (KR)

(72) Inventors: Jae Gil LEE, Yongin-si (KR); Jin Su NAM, Yongin-si (KR); Byeong Beom KIM, Yongin-si (KR); Seung Ho KIM, Yongin-si (KR); Gyu In SHIM, Yongin-si (KR)

(21) Appl. No.: 19/204,214

(22) Filed: May 9, 2025

(30) Foreign Application Priority Data
Jun. 25, 2024 (KR) 10-2024-0082891
Jul. 23, 2024 (KR) 10-2024-0096802

(51) Int. Cl. G06F 1/16

(52) U.S. Cl. CPC G06F 1/1656; G06F 1/1652

(57) ABSTRACT

A method of manufacturing a cover window for a display device that includes forming a mask layer on a window substrate including a first substrate surface, a second substrate surface, and a third substrate surface, and wet-etching the window substrate using an etchant is provided. Forming the mask layer includes forming a first mask and a second mask on the first substrate surface, and forming a third mask on the first mask and the second mask. The first substrate surface includes a bending area etched in wet-etching the window substrate using the etchant, a first flat area positioned on one side of the bending area, and a second flat area positioned on another side of the bending area. The first mask and the second mask have different etching ratios with respect to the etchant, and the first mask and the second mask are on one plane.

### CROSS-REFERENCE TO RELATED APPLICATION

This application claims priority to and the benefit of Korean Patent Application No. 10-2024-0082891, filed on Jun. 25, 2024, and Korean Patent Application No 10-2024-0096802, filed on Jul. 23, 2024, in the Korean Intellectual Property Office, the entire content of each of which is herein incorporated by reference.

### BACKGROUND

### 1. Field

One or more aspects of embodiments of the present disclosure relate to a cover window for a display device and a method of manufacturing the cover window for the display device.

### 2. Description of the Related Art

As information technology develops and the information-oriented society evolves, the significance of display devices, which serve as the interface between users and information, is becoming increasingly prominent.

Known display devices may include a cover window that transmits images displayed on the display device while concurrently or simultaneously protecting the display device from possible damage caused by the external factors (e.g., impacts from drops). To ensure proper image display, enhancements to the external visibility characteristics of the cover window are desired or required.

### SUMMARY

One or more aspects of embodiments of the present disclosure are directed toward a cover window for a display device that may improve (enhance) external visibility, as well as a method of manufacturing the cover window for the display device that may provide the improved external visibility (e.g., manufacturing the cover window to achieve this enhanced visibility).

Additional aspects will be set forth in part in the description which follows and, in part, will be apparent from the description, or may be learned by practice of the presented embodiments of the disclosure.

According to one or more embodiments of the present disclosure, a cover window for a display device may include a first surface and a second surface opposite to (e.g., facing away from) the first surface, and the cover window may further include a first flat area, a second flat area spaced and/or apart (e.g., spaced apart or separated) from the first flat area in one direction, and a bending area between the first flat area and the second flat area. The first surface of the cover window may have a flat shape in each of the first flat area and the second flat area. The bending area may include a first curved area in which the first surface extends in a curved shape from the first flat area, a second curved area in which the first surface extends in a curved shape from the second flat area, and a center area arranged between the first curved area and the second curved area. The first curved area and the center area may meet at a first point, (where) a first tangent line at the first point and the first curved area may form an inclination angle, (e.g., the inclination angle may be between the first tangent line at the first point and the first curved area), and the inclination angle may be at most 1° (e.g., or less).

According to one or more embodiments, the cover window may have a thickness of 50 micrometer (μm) to 200 μm in an area overlapping (e.g., on) the first flat area, and may have a thickness of 20 μm to 100 μm in an area overlapping (e.g., on) the center area.

According to one or more embodiments, the first surface may be flat in the center area.

According to one or more embodiments, a Kc measurement value of the first surface may be at most 0.4 (e.g., or less).

According to one or more embodiments of the present disclosure, a method may include a method of manufacturing a cover window for a display device. The method may include forming a mask layer on a window substrate that includes a first substrate surface, a second substrate surface, and a third substrate surface. The method maty include wet-etching the window substrate (e.g., with (e.g., using) an etchant), and forming the mask layer may include forming each of a first mask and a second mask on the first substrate surface, and forming a third mask on the first mask and the second mask. The first substrate surface may include a bending area etched in (e.g., during) wet-etching the window substrate (e.g., with (e.g., using) the etchant), a first flat area that is arranged on one side of the bending area, and a second flat area that is arranged on a second (e.g., another) side of the bending area. The first mask and the second mask may have different etching ratios with respect to the etchant, (e.g., an etching ratio of the first mask may be different than an etching ratio of the second mask) and the first mask and the second mask may be arranged on one (e.g., a same) plane.

According to one or more embodiments, the first mask may have an etching ratio different from an etching ratio of the third mask with respect to the etchant (e.g., the etching ratio of the first mask may be different than an etching ratio of the third mask).

According to one or more embodiments, the first mask may contact (e.g., may be on) at least a portion of the bending area (e.g., in a plan view), and the etching ratio of the first mask (e.g., for the etchant) may be greater than the etching ratios of each of the second mask and the third mask (e.g., for the etchant).

According to one or more embodiments, the first mask may be (e.g., formed) to expose at least a portion of the bending area.

According to one or more embodiments, the second mask may be (e.g., formed) to cover (e.g., each (e.g., all) of) the first flat area, the second flat area, the second substrate surface, and the third substrate surface, the second substrate surface may be a lower surface of the window substrate, and the third substrate surface may be a side surface of the window substrate.

According to one or more embodiments, the first mask may not include (e.g., may exclude) an acid-resistant material, and the second mask and the third mask may (e.g., each) include an acid-resistant material.

According to one or more embodiments, the first mask may be an adhesive layer that does not include (e.g., excludes) an acid-resistant material, or a metal layer including at least one selected from among titanium (Ti) and indium tin oxide (ITO), the second mask may be an adhesive layer including an acid-resistant material, and the third mask may be an acid-resistant film.

According to one or more embodiments, forming the first mask and the second mask on the first substrate surface and forming the third mask on the first mask and the second mask may include forming a first base mask covering (e.g., on) the bending area, forming a second base mask on the first base mask, peeling off (e.g., removing) at least a portion of the first base mask, peeling off (e.g., removing) at least a portion of the second base mask, and exposing at least a portion of the bending area (e.g., at least the portion of the first base mask and the portion of the second base mask may be peeled off (e.g., removed) to expose at least the portion of the bending area).

According to one or more embodiments, wet-etching the window substrate (e.g., with (e.g., using) the etchant) may include etching the first mask to form an intermediate mask, and ends of the intermediate mask and the third mask may not coincide with each other (e.g., an end portion of the intermediate mask is not on (e.g., coincident with) an end portion of the third mask).

According to one or more embodiments, the intermediate mask may be recessed more than the third mask in a direction toward (e.g., facing) an end of the second mask, (e.g., a recession of the intermediate mask is greater than a recession of the third mask, each recession being)

According to one or more embodiments, wet-etching the window substrate (e.g., with (e.g., using) the etchant) may include etching the bending area to provide an etched bending area, and flowing the etchant between the etched bending area and the third mask.

According to one or more embodiments, wet-etching the window substrate (e.g., with (e.g., using) the etchant) may include isotropically etching the first substrate surface.

According to one or more embodiments, wet-etching the window substrate (e.g., with (e.g., using) the etchant) may include etching the bending area to form a first curved area extending in a curved shape from the first flat area and a second curved area extending in a curved shape from the second flat area, and forming a center area arranged between the first curved area and the second curved area, the first curved area and the center area may meet at a first point, a first tangent line at the first point and the first curved area may form an inclination angle, (e.g., the inclination angle may be between the first tangent line at the first point and the first curved area), and the inclination angle may be at most 1° (e.g., or less).

According to one or more embodiments, the bending area may be etched to have a thickness of 20 μm to 100 μm in an area overlapping (e.g., on) the center area.

According to one or more embodiments, the method may further include removing the mask layer, and removing the mask layer may include irradiating ultraviolet rays (e.g., light) to the mask layer (e.g., the mask layer may be removed by being irradiated with ultraviolet light).

According to one or more embodiments, the method may include further etching the cover window, further etching the cover window may be performed after removing the mask layer, and further etching the cover window may include exposing a first surface of the cover window to an etchant. In other words, the method may further include removing the mask layer, and etching the cover window to expose a first surface of the cover window to the etchant.

According to one or more embodiments, an electronic device may include a display device that includes the cover window of the present disclosure.

According to one or more embodiments, the electronic device may be a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, or a head-mounted display (HMD).

According to one or more embodiments of the present disclosure, a cover window having improved external visibility for a display device may be provided and a method of manufacturing the cover window for the display device that may improve external visibility may be provided.

### BRIEF DESCRIPTION OF THE DRAWINGS

The accompanying drawings are included to provide a further understanding of the preceding and other aspects, features, and advantages of certain embodiments of the present disclosure and are incorporated in and constitute a part of this specification. The drawings illustrate example embodiments that will become more apparent by describing in further detail embodiments thereof with reference to the accompanying drawings. In the drawings:

FIG. 1 is a schematic plan view of a display device according to one or more embodiments;

FIG. 2 is a schematic perspective view of a display device according to one or more embodiments;

FIG. 3 is a schematic perspective view of a cover window according to one or more embodiments;

FIG. 4 is a schematic cross-sectional view along A˜A′ of FIG. 1;

FIG. 5 is a schematic enlarged cross-sectional view of a portion S of FIG. 4;

FIG. 6 is a schematic flowchart illustrating a method of manufacturing a cover window according to one or more embodiments; and

FIGS. 7-13 are schematic cross-sectional views for process steps (e.g., acts or tasks) according to a method of manufacturing a cover window according to one or more embodiments.

### DETAILED DESCRIPTION

Reference will now be made in more detail to one or more embodiments, examples of which are illustrated with reference to the accompanying drawings, and in which example embodiments of the present disclosure are shown. The disclosure may be modified in one or more suitable manners and have one or more suitable forms. Therefore, specific embodiments will be illustrated in the drawings and will be described in more detail in the specification. However, it should be understood that the disclosure is not intended to be limited to the disclosed specific forms, and the disclosure includes all modifications, equivalents, and substitutions within the spirit and technical scope of the disclosure.

The terms “first”, “second”, and/or the like, may be used herein to describe one or more suitable components, but the components should not be limited by the terms. The terms are used only for the purpose of distinguishing one component from another component. For example, without departing from the scope of the disclosure, a first component may be referred to as a second component, and similarly, a second component may also be referred to as a first component. In the following description, the singular expressions such as “a,” “an,” and “the” include plural expressions unless the context clearly dictates otherwise. The same reference numbers indicate the same components throughout the specification, and thus redundant descriptions thereof will not be provided. Sizes of elements in the drawings may be exaggerated for convenience of explanation. In other words, because sizes and thicknesses of components in the drawings are arbitrarily illustrated for convenience of explanation, the following embodiments are not limited thereto.

It should be understood that although terms such as “comprises,” “comprising,” “comprise,” “includes,” “including,” “include,” “have,” “has,” “having,” and/or the like are used to describe a feature, a number, a step (e.g., act or task), an operation, a component, a part, and/or a (e.g., any suitable) combination thereof in the specification, use of such terms should not exclude a possibility of the presence or addition of one or more other features, numbers, steps (e.g., acts or tasks), operations, components, parts, and/or one or more (e.g., any suitable) combinations thereof in advance. In some embodiments, a case where a portion of a layer, a substrate, an area, a plate, and/or the like is referred to as being “on” another portion, it includes not only a case where the portion is “directly on” another portion, but also a case where an intervening layer or substrate is further between the portion and the other portion.

Each of the features of the one or more embodiments may be combined or combined with each other, in part or in whole, and each embodiment may be implemented independently of each other or may be implemented together in an association.

In some embodiments, in the present specification, spatially relative terms, such as “beneath,” “below,” “lower,” “above,” “upper,” “bottom,” “top,” and the like, may be used herein for ease of description to describe the relationship of one element or feature to another element(s) or feature(s) as illustrated in the drawings. For example, if (e.g., when) a portion of a layer, a substrate, an area, a plate, and/or the like is formed on another portion, a forming direction is not limited to an upper direction but may include forming the portion on a side surface or in a lower direction. In contrast, if (e.g., when) a portion of a layer, a substrate, an area, a plate, and/or the like is formed “under” another portion, this includes not only a case where the portion is “directly beneath” another portion but also a case where there is an intervening portion between the portion and the other portion. Thus, the term “below” may encompass both an orientation of above and below. The device may be otherwise oriented (rotated 90 degrees or at other orientations), and the spatially relative descriptors used herein should be interpreted accordingly.

Unless otherwise defined, all chemical names, technical and scientific terms, and terms defined in common dictionaries should be interpreted as having meanings consistent with the context of the related art, and should not be interpreted in an ideal or overly formal sense.

As used herein, the term “and/or” includes any and all combinations of one or more of the associated listed items. Expressions such as “at least one of,” “one of,” “selected from,” and “selected from among,” when preceding a list of elements, modify the entire list of elements and do not modify the individual elements of the list. For example, throughout the disclosure, the expression “at least one of a, b or c” indicates only a, only b, only c, both (e.g., simultaneously) a and b, both (e.g., simultaneously) a and c, both (e.g., simultaneously) b and c, all of a, b, and c, or variations thereof.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In this context, “consisting essentially of” indicates that any additional components will not materially affect the chemical, physical, optical or electrical properties of the semiconductor film.

Further, in this specification, the phrases “on a plane” and “plan view” indicate viewing a target portion from the top, and the term “cross-section” indicates viewing a cross-section formed by vertically cutting a target portion from the side.

The disclosure relates to a cover window for a display device and a method of manufacturing the cover window for the display device. Hereinafter, a cover window for a display device and a method of manufacturing the cover window for the display device according to one or more embodiments are described with reference to the accompanying drawings.

### Display Device

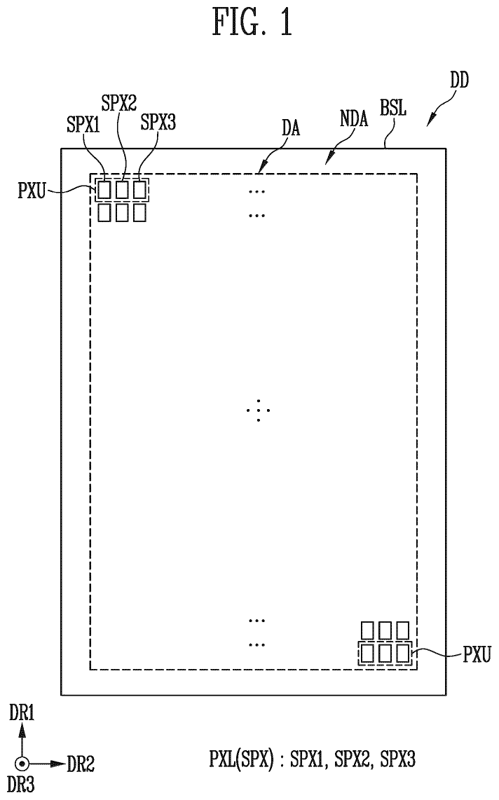

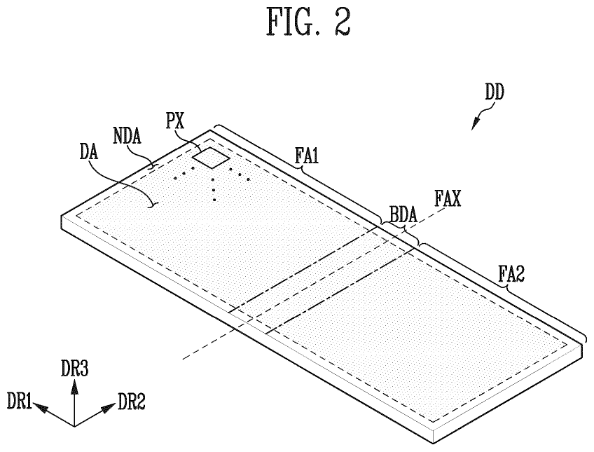

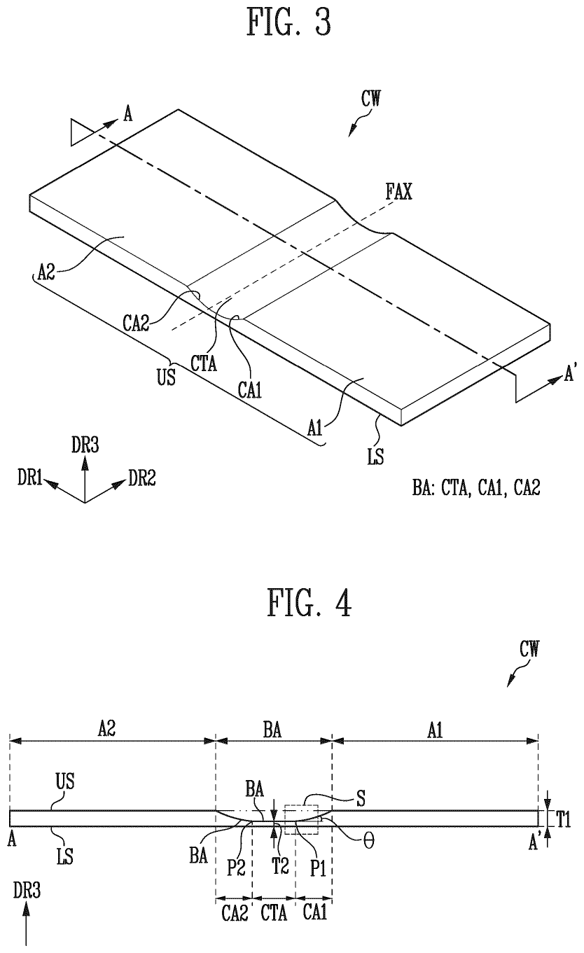

First, with reference to FIGS. 1 and 2, a display device DD including a cover window CW (refer to FIG. 3) according to one or more embodiments is schematically described.

FIG. 1 is a schematic plan view of a display device (e.g., of an electronic device) according to one or more embodiments. FIG. 2 is a schematic perspective view of a display device according to one or more embodiments. FIG. 2 illustrates a display device DD having a flexible characteristic as an example of the display device DD.

Referring to FIG. 1, the display device DD is configured to emit light. The display device DD may include a light emitting element. According to one or more embodiments, the display device DD may be a device for displaying a moving image or a still image. The display device DD may be used as a display screen of one or more suitable products (electronic devices) such as a portable electronic device such as a mobile phone, a smart phone, a tablet personal computer (PC), a smart watch, a watch phone, a mobile communication terminal, an electronic notebook, an electronic book, a portable multimedia player (PMP), a navigation device, an ultra mobile PC (UMPC), and/or the like. The display device DD may be used as a display screen of one or more suitable products such as a television, a notebook computer, a monitor, a billboard, the Internet of things (IOT), and/or the like. However, an application field of the display device DD is not limited to a specific example.

The display device DD may be formed in a plane of a rectangular shape having a long side of a first direction DR1 and a short side of a second direction DR2 crossing the first direction DR1. A corner where the long side of the first direction DR1 and the short side of the second direction DR2 meet may be formed to be rounded to have a set or predetermined curvature or may be formed in a right angle. A planar shape of the display device DD is not limited to a quadrangle, and may be formed in another polygon or may be formed in a round shape such as a circle or an ellipse. The display device may be formed to be flat, but the present disclosure is not limited thereto. For example, the display device DD may include a curved portion formed at left and right ends and having a constant curvature or a varying curvature.

In the disclosure, the first direction DR1 may be a column direction of a pixel PXL. The second direction DR2 may be a “horizontal” direction as a row direction of the pixel PXL. A third direction DR3 may be a display direction of the display device DD or a normal direction of a plane where a base layer BSL is arranged.

The display device DD may include a display area DA and a non-display area NDA. The non-display area NDA may refer to an area other than the display area DA. The non-display area NDA may be around (e.g., surround) at least a portion of the display area DA.

The display area DA may refer to an area where the pixel PXL is arranged. The non-display area NDA may refer to an area where the pixel PXL is not arranged. A driving circuit unit, lines, and pads connected to the pixel PXL of the display area DA may be arranged in the non-display area NDA.

According to one or more embodiments, the pixel PXL (or sub-pixels SPX) may include a first sub-pixel SPX1, a second sub-pixel SPX2, and a third sub-pixel SPX3. At least one of the first sub-pixel SPX1, the second sub-pixel SPX2, or the third sub-pixel SPX3 may form one pixel unit PXU capable of emitting light of one or more suitable colors. In FIG. 1, one or more embodiments in which each pixel PXL includes three sub-pixels SPX1, SPX2, and SPX3, that is, the first sub-pixel SPX1, the second sub-pixel SPX2, and the third sub-pixel SPX3 is exemplified, one or more embodiments of the present specification is not limited thereto.

According to one or more embodiments, the pixel PXL (or the sub-pixels SPX) may be arranged according to a stripe or PENTILE® form or structure, (e.g., an RGBG matrix, an RGBG structure, or an RGBG matrix structure) arrangement structure and/or the like. PENTILE® is a registered trademark owned by the Samsung Display Co., Ltd. However, the disclosure is not necessarily limited thereto.

The first sub-pixel SPX1 may be to emit a first light, the second sub-pixel SPX2 may be to emit a second light, and the third sub-pixel SPX3 may be to emit a third light. Here, the first light may be light of a red wavelength band, the second light may be light of a green wavelength band, and the third light may be light of a blue wavelength band. The red wavelength band may be a wavelength band of about 600 nanometer (nm) to about 750 nm, the green wavelength band may be a wavelength band of about 480 nm to about 560 nm, and the blue wavelength band may be a wavelength band of about 370 nm to about 460 nm, but one or more embodiments of the present specification is not limited thereto.

Each of the first sub-pixel SPX1, the second sub-pixel SPX2, and the third sub-pixel SPX3 may include an inorganic light emitting element including an inorganic semiconductor or an organic light emitting element (organic light emitting diode (OLED) as a light emitting element that emits light. However, the disclosure is not limited to a specific example.

The display device DD may be flexibly formed so as to be bent, curved, folded, rolled, and/or the like.

For example, the display device DD may have a flat state or a folding state. For example, as shown in FIG. 2, the display device DD may be entirely spread out flat, and the display device DD may be folded along a folding axis FAX. The display device DD may include a bending area (bendable area) BDA where the display device DD may be bent, and a first flat area FA1 and a second flat area FA2 on both sides (e.g., opposite sides) of the bending area BDA. The first flat area FA1 and the second flat area FA2 may be arranged adjacent to (or in contact with) the bending area BDA.

The bending area BDA may be a portion that may be bent if (e.g., when) the display device DD is folded, and the first flat area FA1 and the second flat area FA2 may be portions that are not bent.

In the drawings, one bending area BDA is shown, but the display device DD may include a plurality of bending areas BDA that are spaced and/or apart (e.g., spaced apart or separated) from each other or may be bent with different radii of curvature. For example, the display device DD may include two or more bending areas and three or more flat areas.

The display device DD may be folded so that a screen portion of the first flat area FA1 and a screen portion of the second flat area FA2 face each other (hereinafter, referred to as in-folding). The display device DD may be folded so that a screen is exposed to an outside (hereinafter, referred to as out-folding). In an in-folding state, a screen portion of the bending area BDA may be covered. In an out-folding state, a screen portion of the bending area BDA may be exposed so that a user may see the screen portion. The display device DD may be designed so that only one selected from among in-folding and out-folding is possible, or both (e.g., simultaneously) selected from among in-folding and out-folding are possible. When the display device DD includes a plurality of bending areas BDA, one selected from among the plurality of bending areas BDA may be a bending area where in-folding is possible, and another of the plurality of bending areas BDA may be a bending area where out-folding is possible.

The display device DD may further include a housing, and one or more suitable parts configuring the display device DD, for example, a display panel, a driving device, a printed circuit board, an application processor, a memory, a speaker, one or more suitable sensors, and/or the like may be positioned in a space limited by the cover window CW and the housing. The display device DD according to the disclosure may have improved impact resistance by including the cover window CW according to the disclosure.

In one or more embodiments, the display device DD may be a component of and/or applied to portable electronic devices such as smartphones, televisions, monitors, tablets, electric vehicles, mobile phones, tablet personal computers (PC), mobile communication terminals, electronic notebooks, electronic books, portable multimedia players (PMP), navigation devices, ultra-mobile personal computers (UMPC), laptop computers, billboards, Internet of Things (IoT) devices, smartwatches, watch phones, or head-mounted displays (HMD). For example, the display device DD may be applied to a display unit of a television, a laptop computer, a monitor, a billboard, or the Internet of Things (IoT). Alternatively, in one or more embodiments, the display device DD may be applied to a smartwatch, a watch phone, and/or a head-mounted display device (HMD) for implementing virtual reality and/or augmented reality.

### Cover Window

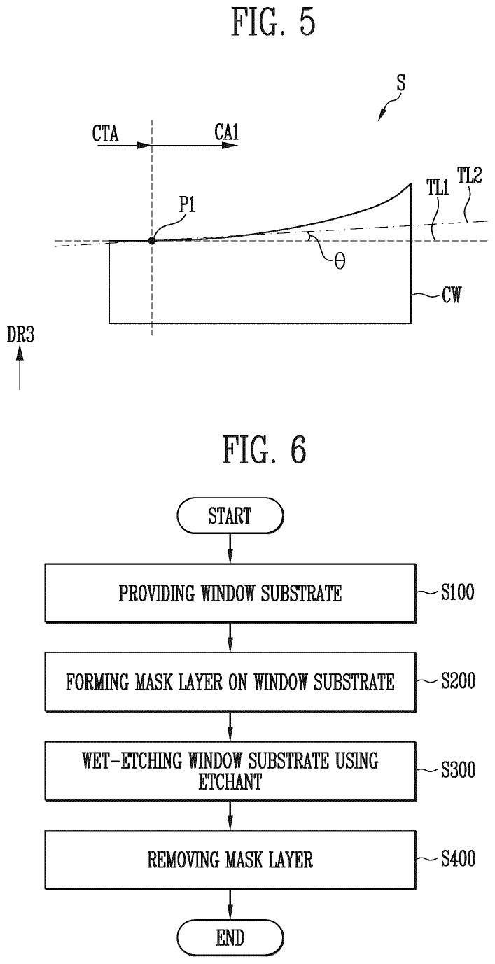

Hereinafter, with reference to FIGS. 3 to 5, the cover window CW is described. FIG. 3 is a schematic perspective view of a cover window according to one or more embodiments. FIG. 4 is a schematic cross-sectional view along A˜A′ of FIG. 1. FIG. 5 is a schematic enlarged cross-sectional view of a portion S of FIG. 4.

Referring to FIGS. 3 to 5, the cover window CW may include a first surface US and a second surface LS. The first surface US may be an upper surface of the cover window CW. The second surface LS may be a lower surface of the cover window CW. The first surface US and the second surface LS may be opposite surfaces. The second surface LS may be a surface opposite to (e.g., facing away from) the first surface US. For example, these surfaces are opposite to each other, with the second surface LS facing away from the first surface US.

In one or more embodiments, the second surface LS of the cover window CW may extend in the first direction DR1 and the second direction DR2. The second surface LS of the cover window CW may be flat or substantially flat. In one or more embodiments, the second surface LS of the cover window CW may include a curved surface. In still one or more embodiments, the second surface LS of the cover window CW may have a shape symmetrical to the first surface US of the cover window CW.

The first surface US of the cover window CW may include a bending area BA, a first flat area A1, and a second flat area A2. The bending area BA, the first flat area A1, and the second flat area A2 may be areas that overlap the bending area BA, the first flat area FA1, and the second flat area FA2 of the display device DD, respectively, if (e.g., when) the cover window CW is arranged in the display device DD in a plan view. The bending area BA may be arranged between the first flat area A1 and the second flat area A2. The bending area BA may include a center area CTA, a first curved area CA1, and a second curved area CA2.

According to one or more embodiments, a layer including at least one of an organic material or an inorganic material may be further arranged on the bending area BDA. The layer including at least one of (e.g., selected from among) the organic material and/or the inorganic material may fill a concave area formed by the first flat area A1 and the second flat area A2 and the bending area BDA.

For example, according to one or more embodiments, a resin layer may be further arranged on the bending area BDA. For example, the resin layer may be further arranged on the bending area BDA, and the resin layer may fill a concave area formed by the first flat area A1 and the second flat area A2 and the bending area BDA.

According to one or more embodiments, the resin layer arranged on the bending area BDA may include at least one of (e.g., selected from among) acrylic resin (polyacrylates resin), epoxy resin, phenol resin, polyamides resin, polyimides resin, unsaturated polyesters resin, poly-phenylene ethers resin, poly-phenylene sulfides resin, and/or benzocyclobutene resin.

The center area CTA may extend in the first direction DR1 and the second direction DR2. The center area CTA may refer to an area where the first surface US has a flat or substantially flat shape.

The center area CTA may overlap a folding axis FAX. The cover window CW may be folded around the folding axis FAX, and the center area CTA may be an area bent if (e.g., when) the cover window CW is folded. The center area CTA may be flat, and the flat center area CTA may reduce bending reaction force and/or stress occurring if (e.g., when) the cover window CW is bent.

The first curved area CA1 may be arranged on one side of the center area CTA. The first curved area CA1 may extend in a curved shape from one side of the center area CTA (or the first flat area A1). The first curved area CA1 may refer to an area where at least a portion of the first surface US is inclined e.g., because an area where the first surface US is not flat.

In one or more embodiments, the first curved area CA1 may extend in the first direction DR1 and the third direction DR3. In one or more embodiments, the first curved area CA1 may be concave. That the first curved area CA1 is concave may refer to that a center of curvature of the first curved area CA1 is on the first surface US of the cover window CW. For example, the center of curvature of the first curved area CA1 may be spaced and/or apart (e.g., spaced apart or separated) from the first surface US of the cover window CW in the third direction DR3. In one or more embodiments, the first curved area CA1 may be convex. That the first curved area CA1 is convex may refer to that the center of curvature of the first curved area CA1 is under the first surface US of the cover window CW. For example, the center of curvature of the first curved area CA1 may be spaced and/or apart (e.g., spaced apart or separated) from the first surface US of the cover window CW in a direction opposite to (e.g., pointing away from) the third direction DR3. For example, the center of curvature of the first curved area CA1 may be spaced apart from the first surface US of the cover window CW in a direction opposite to the third direction DR3. In one or more embodiments, the first curved area CA1 may be concave and convex.

The first curved area CA1 and the center area CTA may meet at a first point P1. The first curved area CA1 may extend in a curved shape from the first point P1. The first curved area CA1 may have a virtual first tangent line TL1 at the first point P1. The virtual first tangent line TL1 may extend in the first direction DR1.

The first curved area CA1 may have a virtual second tangent line TL2 at a point (for example, a point immediately adjacent to the first point P1) on the first curved area CA1 other than the first point P1 of the first curved area CA1. The second tangent line TL2 may extend in a direction inclined with respect to the third direction DR3. The second tangent line TL2 may not be parallel to the first tangent line TL2. The second tangent line TL2 may meet the first tangent line TL1. The second tangent line TL2 may form an inclination angle θ with the first tangent line TL1. For example, the inclination angle θ may be an angle formed by (e.g., between) the first tangent line TL1 and the first curved area CA1.

The inclination angle θ may be an angle formed by (e.g., between) the second tangent line TL2 and a plane of the center area CTA. The inclination angle θ may be at most 1° (e.g., or less). The inclination angle θ may be at most 1° (e.g., or less), and if (e.g., when) the cover window CW is viewed on a plane, an extent or risk that a boundary between the center area CTA and the first curved area CA1 is observed or recognized may be reduced. When the boundary between the center area CTA and the first curved area CA1 is observed or recognized, external visibility of the display device DD (or the cover window CW) may be reduced, but the boundary between the center area CTA and the first curved area CA1 may not be observed or recognized in the display device DD (or the cover window CW) according to one or more embodiments of the present disclosure.

The first flat area A1 may be arranged at one side of the bending area BA. The first flat area A1 may extend from the first curved area CA1 in a direction opposite to the first direction DR1 and in the second direction DR2. The first flat area A1 may refer to an area where the first surface US has a flat or substantially flat shape.

The first flat area A1 may be an area that is not bent if (e.g., when) the cover window CW is folded. The cover window CW may be arranged on a display panel, and in one or more embodiments, a thickness of the cover window CW in the first flat area A1 may be thicker than a thickness of the cover window CW in the center area CTA. For example, the cover window CW may have a first thickness T1 of 50 micrometer (μm) to 200 μm in an area overlapping (e.g., on) the first flat area A1, and the cover window CW may have a second thickness T2 of 20 μm to 100 μm in an area overlapping (e.g., on) the center area CTA. When the cover window CW has a thickness of less than 20 μm, impact resistance may be excessively (or substantially) reduced if (e.g., when) the cover window CW is bent. When the cover window CW has a thickness of more than 100 μm, a bending repulsion force of the cover window CW may be excessively (or substantially) increased if (e.g., when) the cover window CW is bent. The bending repulsion force of the cover window CW according to the present disclosure may be minimized or reduced in the center area CTA if (e.g., when) the cover window CW is folded, and damage to the display panel may be prevented, minimized or reduced.

The second curved area CA2 may be arranged at a second (e.g., an other) side of the center area CTA. The second curved area CA2 may extend in a curved shape from the second (e.g., other) side of the center area CTA (or the second flat area A2). For example, the second curved area CA2 and the center area CTA may meet at a second point P2, and the second curved area CA2 may extend in a curved shape from the second point P2. In one or more embodiments, the second curved area CA2 may extend in the first direction DR1 and the third direction DR3. In one or more embodiments, the second curved area CA2 may be concave. In one or more embodiments, the second curved area CA2 may be convex. In still one or more embodiments, the second curved area CA2 may be concave and convex.

A tangent line (e.g., an imaginary tangent line) at a point (for example, a point immediately adjacent to the second point P2) on the second curved area CA2 other than the second point P2 of the second curved area CA2 and tangent line (e.g., imaginary tangent line) at the second point P2 of the second curved area CA2 may form an inclination angle θ. The inclination angle θ may be at most 1° (e.g., or less), and an extent or risk that a boundary between the center area CTA and the second curved area CA2 is observed or recognized may be reduced.

The second flat area A2 may be arranged on a second (e.g., an other) side of the bending area BA. The second flat area A2 may extend from the second curved area CA2 in the first direction DR1 and the second direction DR2. The second flat area A2 may refer to an area where the first surface US has a flat or substantially flat shape.

The second flat area A2 may be an area that is not bent if (e.g., when) the cover window CW is folded. In an area overlapping (e.g., on) the second flat area A2, the cover window CW may have a thickness of 50 μm to 200 μm.

### Method of Manufacturing a Cover Window

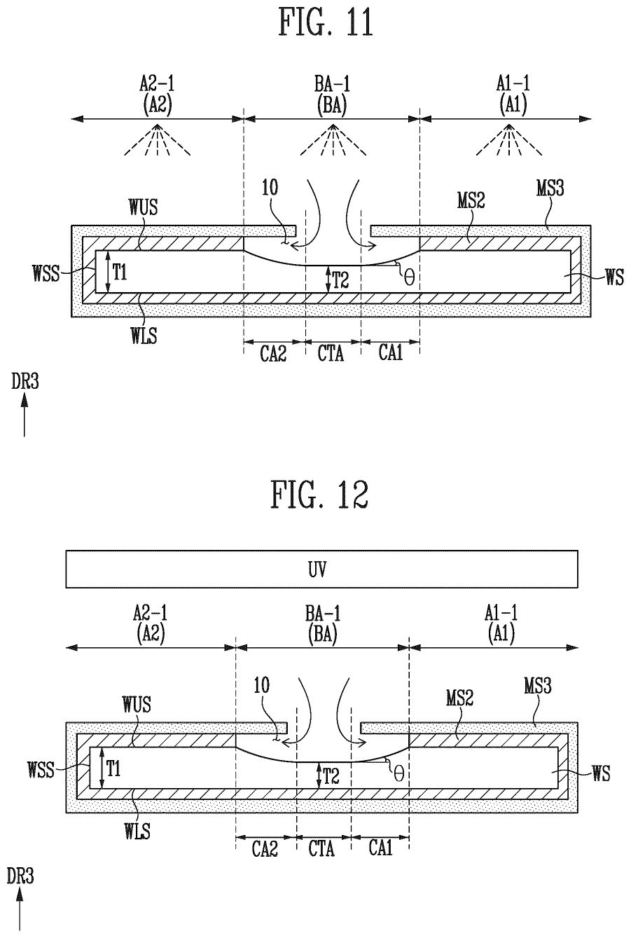

Hereinafter, with reference to FIGS. 6 to 13, a method of manufacturing the cover window CW is described.

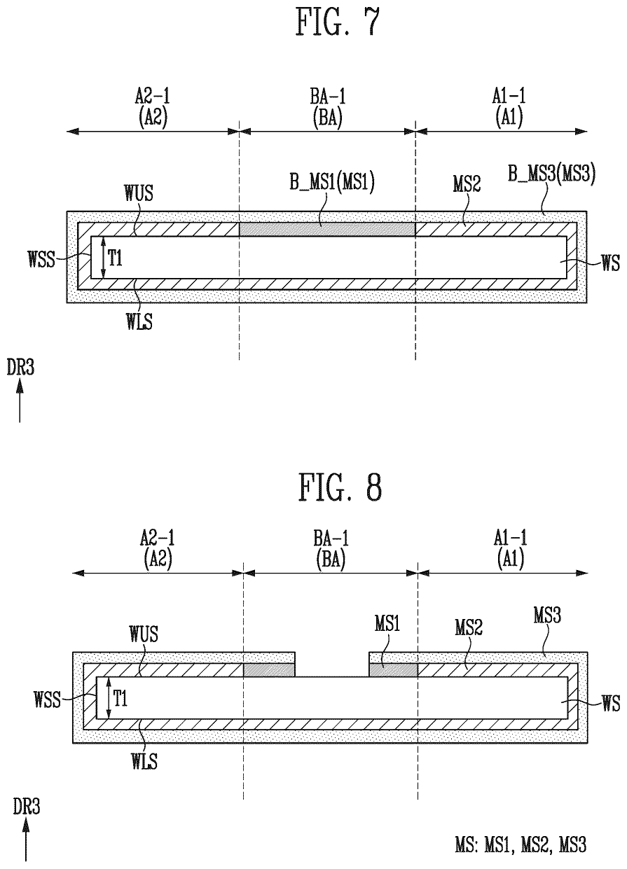

FIG. 6 is a schematic flowchart illustrating a method of manufacturing a cover window according to one or more embodiments. FIGS. 7 to 13 are schematic cross-sectional views for each process step (e.g., act or task) according to a method of manufacturing a cover window according to one or more embodiments.

Referring to FIG. 6, the method of manufacturing the cover window CW may include providing a window substrate (S100), forming a mask layer on the window substrate (S200), wet-etching the window substrate using an etchant (S300), and removing the mask layer (S400).

Referring to FIGS. 7 and 8, providing the window substrate (S100) may be or include preparing an optically transparent window substrate WS. The window substrate WS may be an ultra-thin glass (UTG). According to one or more embodiments, the window substrate WS may include soda lime glass, alkali alumino silicate glass, borosilicate glass, and/or lithium alumina silicate glass.

The window substrate WS may include a first substrate surface WUS, a second substrate surface WLS, and a third substrate surface WSS.

The first substrate surface WUS may be an upper surface of the window substrate WS. The first substrate surface WUS may be a surface exposed to the etchant if (e.g., when) the window substrate WS is etched. At least a portion of the first substrate surface WUS may be etched to form the first surface US of the cover window CW.

The first substrate surface WUS may include a bending area BA-1, a first flat area A1-1, and a second flat area A2-1. The first flat area A1-1 and the second flat area A2-1 may be spaced and/or apart (e.g., spaced apart or separated) in the first direction DR1 with the bending area BA-1 therebetween. The respective first flat area A1-1 and second flat area A2-1 of the window substrate WS may be areas forming the first flat area A1 and the second flat area A2 of the cover window CW. The bending area BA-1 may be arranged between the first flat area A1-1 and the second flat area A2-1. The bending area BA-1 may be an area where at least a portion of the first substrate surface WUS is etched, and may be an area forming the bending area BA of the cover window CW.

The second substrate surface WLS may be a lower surface of the window substrate WS. The first substrate surface WUS and the second substrate surface WLS may be opposite surfaces. The second substrate surface WLS may be a surface facing the first substrate surface WUS. For example, the second substrate surface WLS may face the first substrate surface WUS.

The third substrate surface WSS may be a side surface of the window substrate WS. The third substrate surface WSS may be a surface sharing at least one edge with each of the first substrate surface WUS and the second substrate surface WLS.

Forming the mask layer on the window substrate (S200) may include forming a first mask MS1, a second mask MS2, and a third mask MS3. For example, a mask layer MS may include the first mask MS1, the second mask MS2, and the third mask MS3.

Forming the first mask MS1 and the second mask MS2 may include forming the first mask MS1 on at least a portion of the first substrate surface WUS of the window substrate WS and forming the second mask MS2 on at least a portion of the first substrate surface WUS of the window substrate WS, the second substrate surface WLS, and the third substrate surface WSS.

In forming the first mask MS1 and the second mask MS2, an area where the first mask MS1 is formed may correspond to at least a portion of the bending area BA-1. An area where the first mask MS1 is formed may overlap at least a portion of the bending area BA-1 in a plan view. In FIG. 7, the area where the first mask MS1 is formed is shown as overlapping only the bending area BA, but the disclosure is not limited thereto.

For example, according to one or more embodiments, at least a portion of the area where the first mask MS1 is formed may correspond to at least a portion of the first flat area A1-1 and the second flat area A2-1. At least a portion of the area where the first mask MS1 is formed may overlap at least a portion of the first flat area A1-1 and the second flat area A2-1 in a plan view.

The first mask MS1 may contact at least a portion of the first substrate surface WUS. The first mask MS1 may be directly arranged on at least a portion of the first substrate surface WUS. The first mask MS1 may contact at least a portion of the bending area BA-1. The first mask MS1 may be directly arranged on at least a portion of the bending area BA-1.

In FIG. 7, a surface that the first mask MS1 is on (e.g., contacts) is shown as being one surface (for example, the first substrate surface WUS), but the disclosure is not limited thereto. The first mask MS1 may be arranged on a surface of the window substrate WS that is to be etched. For example, if (e.g., when) the second substrate surface WLS is to be etched, the first mask MS1 may also be arranged on the second substrate surface WLS. Hereinafter, for convenience, the disclosure is described in more detail based on one or more embodiments in which the first substrate surface WUS is etched.

According to one or more embodiments, the first mask MS1 may be a layer formed by peeling off (e.g., removing) at least a portion of a first base mask B_MS1. For example, forming the mask layer on the window substrate (S200) may include forming the first base mask B_MS1 on the first substrate surface WUS to cover the bending area BA-1, forming the second mask MS2 on the first substrate surface WUS where the first base mask B_MS1 is not arranged, forming a second base mask B_MS3 on the first base mask B_MS1 and the second mask MS2, and peeling off (e.g., removing) at least a portion of the first base mask B_MS1 and the second base mask B_MS3.

In forming the first base mask B_MS1 and the second mask MS2, the first base mask B_MS1 and the second mask MS2 may be arranged on one (e.g., a same) plane (for example, the bending area BA-1).

According to one or more embodiments, in peeling off (e.g., removing) at least a portion of the first base mask B_MS1 and the second base mask B_MS3, at least a portion of each of the first base mask B_MS1 and the second base mask B_MS3 may be peeled off (e.g., removing) with a knife. At least a portion of each of the first base mask B_MS1 and the second base mask B_MS3 may be peeled off (e.g., removed), and thus at least a portion of the bending area BA-1 of the window substrate WS may be exposed. For example, the first mask MS1 may expose at least a portion of the bending area BA-1. However, the disclosure is not limited thereto. According to one or more embodiments, the first mask MS1 and the third mask MS3 that are formed in advance may be arranged on the bending area BA-1. For example, the first base mask B_MS1 and the second base mask B_MS3 may be cut before the first base mask B_MS1 and the second base mask B_MS3 are arranged on the bending area BA-1, and cut first mask MS1 and third mask MS3 may be arranged on the bending area BA-1. The cut first mask MS1 and third mask MS3 may expose at least a portion of the bending area BA-1.

The first mask MS1 may have an etching ratio with respect to the window substrate WS etchant, which is greater (e.g., higher) than that of each of an etching ratio of the second mask MS2 and an etching ratio of the third mask MS3. The first mask MS1 may be more easily etched with the window substrate WS etchant than each of the second mask MS2 and the third mask MS3. The first mask MS1 may have an etching rate with respect to the window substrate WS etchant, which is greater (e.g., higher) than that of each of an etching rate the second mask MS2 and an etching rate the third mask MS3. For example, if (e.g., when) the first mask MS1, the second mask MS2, and the third mask MS3 are etched with the window substrate WS etchant, the first mask MS1 may be etched more than (e.g., each of) the second mask MS2 and/or the third mask MS3. For example, if (e.g., when) the first mask MS1, the second mask MS2, and the third mask MS3 are etched with the window substrate WS etchant, the first mask MS1 may be etched, and the second mask MS2 and/or the third mask MS3 may not be etched. For example, the first mask MS1 may have a higher etching ratio with respect to the window substrate WS etchant compared to the second mask MS2 and the third mask MS3. This refers to that the first mask MS1 is more easily etched by the window substrate WS etchant than the second and third masks. For example, the etching rate of the first mask MS1 with the window substrate WS etchant is greater than that of the second mask MS2 and the third mask MS3.

The first mask MS1 may be a layer that is soluble in acid. According to one or more embodiments, the first mask MS1 may be an adhesive layer that does not include an (e.g., excludes any) acid-resistant material. According to one or more embodiments, the first mask MS1 may include a material that is soluble in acid. According to one or more embodiments, the first mask MS1 may be a metal layer that is soluble in acid. For example, the first mask MS1 may be a metal layer including at least one of (e.g., selected from among) titanium (Ti) and/or indium tin oxide (ITO). For example, the first mask MS1 may be an adhesive layer without an acid-resistant material, or a metal layer soluble in acid. For example, the first mask MS1 could be a metal layer containing titanium (Ti) or indium tin oxide (ITO).

In forming the first mask MS1 and the second mask MS2, an area where the second mask MS2 is formed may correspond to the first flat area A1-1 and the second flat area A2-1. The area where the second mask MS2 is formed may overlap (e.g., be on) the first flat area A1-1 and the second flat area A2-1 in a plan view. The second mask MS2 may contact (e.g., be on) the first flat area A1-1 and the second flat area A2-1. The second mask MS2 may be directly arranged on the first flat area A1-1 and the second flat area A2-1.

The second mask MS2 may contact (e.g., be on) at least a portion of the first substrate surface WUS where the first mask MS1 is not arranged. The second mask MS2 may be directly arranged on at least a portion of the first substrate surface WUS where the first mask MS1 is not arranged. At least a portion of the second mask MS2 may be arranged on the same plane as the first mask MS1. A side surface of the second mask MS2 and a side surface of the first mask MS1 may be in contact with (e.g., be on) each other.

An area where the first mask MS1 and the second mask MS2 are arranged on the first substrate surface WUS may be controlled or selected according to an area to be etched, and according to the method of manufacturing the cover window CW according to the disclosure, the area to be etched may be appropriately or suitably etched. According to the method of manufacturing the cover window CW according to the disclosure, a disposition area of the first mask MS1 and the second mask MS2 may be controlled or selected. Therefore, an etching process may be simplified, a process cost may be reduced because an additional process is not desired or required.

The second mask MS2 may contact (e.g., be on) the second substrate surface WLS. The second mask MS2 may be directly arranged on the second substrate surface WLS. According to one or more embodiments, the second mask MS2 may entirely cover (e.g., be on) the second substrate surface WLS.

The second mask MS2 may contact (e.g., be on) the third substrate surface WSS. The second mask MS2 may be directly arranged on the third substrate surface WSS. According to one or more embodiments, the second mask MS2 may entirely cover (e.g., be on) the third substrate surface WSS.

The second mask MS2 may be an adhesive layer including an acid-resistant material. The acid-resistant material may be a material that is resistant to acid, and may refer to acid-resistant materials suitable in the art that are relatively not etched by acid. For example, the acid-resistant material may refer to a material that does not chemically react with strong acid or hydrofluoric acid. The second mask MS2 may include the acid-resistant material and may not be etched by an etchant of the window substrate WS. As the second mask MS2 including the acid-resistant material covers an area (for example, the first flat area A1-1, the second flat area A2-1, the second substrate surface WLS, and the third substrate surface WSS) excluding the bending area BA-1, if (e.g., when) etching the window substrate WS, the second mask MS2 may protect the area excluding the bending area BA-1 from the etchant. For example, the area excluding the bending area BA-1 may be an area where etching is not desired or suitable, and may not be etched by the etchant.

The third mask MS3 may be arranged on the first mask MS1 and the second mask MS2. The third mask MS3 may contact (e.g., be on) the first mask MS1 and the second mask MS2. The third mask MS3 may be directly arranged on the first mask MS1 and the second mask MS2. The third mask MS3 may cover (e.g., be on) an upper surface of each of the first mask MS1 and the second mask MS2.

An end of the third mask MS3 may correspond to an end of the first mask MS1. The end of the third mask MS3 may coincide with (e.g., be coincident with or on) the end of the first mask MS1. The end of the third mask MS3 may overlap (e.g., be on) the end of the first mask MS1 in a plan view. For example, the end of the third mask MS3 may align with the end of the first mask MS1. In a plan view, the end of the third mask MS3 may coincide with or overlap the end of the first mask MS1.

According to one or more embodiments, the third mask MS3 may be a layer formed by peeling off (e.g., removing) at least a portion of the second base mask B_MS3. For example, as described herein, at least a portion of the second base mask B_MS3 may be peeled off (e.g., removed) with a knife, and thus the third mask MS3 may be formed. At least a portion of the second base mask B_MS3 and the first base mask B_MS1 may be peeled off (e.g., removed) with a knife, and at least a portion of the bending area BA-1 of the window substrate WS may be exposed. For example, the first mask MS1 and the third mask MS3 may not overlap (e.g., be on) at least a portion of the bending area BA-1 in a plan view.

The third mask MS3 may be an acid-resistant film including an acid-resistant material. The third mask MS3 may include an acid-resistant material and may not be etched by the window substrate WS etchant.

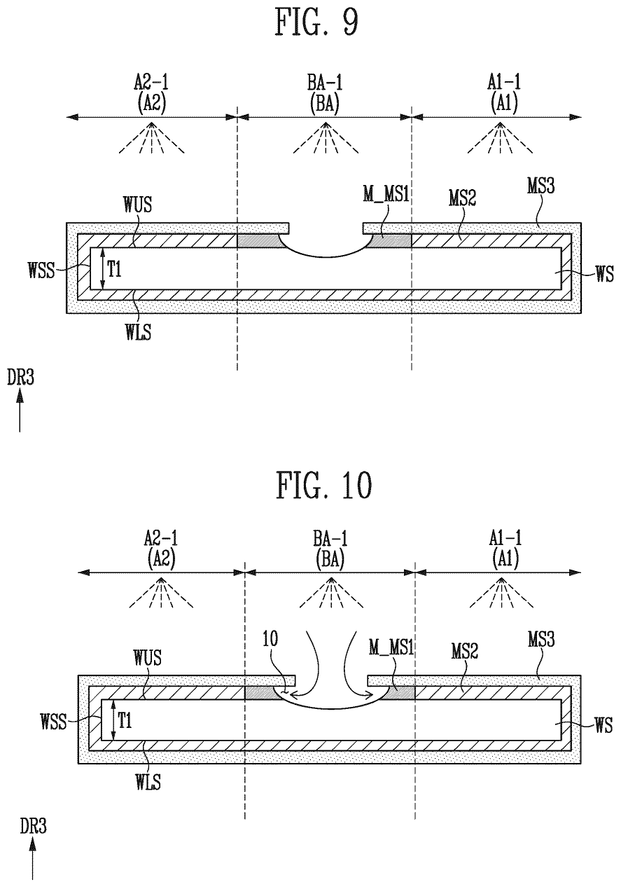

Referring to FIGS. 9 to 11, wet-etching the window substrate using the etchant (S300) may include etching at least a portion (for example, the bending area BA-1) of the first substrate surface WUS using the etchant. Wet-etching the window substrate using the etchant (S300) may include isotropically etching at least a portion (for example, the bending area BA-1) of the first substrate surface WUS. The etchant may include at least one of (e.g., selected from among) hydrofluoric acid (HF), ammonium fluoride (NH₄F), and/or nitric acid (HNO₃). The phrase “isotropically etching” as used herein indicates that etching in more than direction is performed to the same quantitative amount in each direction.

At least a portion (for example, the bending area BA-1) of the first substrate surface WUS may be wet-etched. The exposed bending area BA-1 of the first substrate surface WUS may be exposed to the etchant, and the exposed bending area BA-1 of the first substrate surface WUS may be etched.

In wet-etching the window substrate using the etchant (S300), if (e.g., when) at least a portion (for example, the bending area BA-1) of the first substrate surface WUS is etched, the first mask MS1 may also be etched together. As the first mask MS1 does not include an acid-resistant material, the first mask MS1 may be etched by the etchant.

Wet-etching the window substrate using the etchant (S300) may include etching the first mask MS1 to form an intermediate mask M_MS1. The first mask MS1 may be etched, and the intermediate mask M_MS1 may be formed. The intermediate mask M_MS1 may refer to the first mask MS1 that is exposed to the etchant and etched.

An end of the intermediate mask M_MS1 may not coincide with (e.g., be coincident with or on) the end of the third mask MS3. For example, the end of the intermediate mask M_MS1 may not overlap (e.g., be on) the end of the third mask MS3 in a plan view. The intermediate mask M_MS1 may have a structure that is more inwardly recessed than the third mask MS3. For example, compared to the third mask MS3, the intermediate mask M_MS1 may have a structure that is more inwardly recessed in a direction toward (e.g., facing) an end of the second mask MS2. The third mask MS3 may have a structure that protrudes outwardly more than the intermediate mask M_MS1. For example, the third mask MS3 may have a structure that protrudes more than the intermediate mask M_MS1 in a direction in which the end of the second mask MS2 faces. For example, the end of the intermediate mask M_MS1 may not coincide with the end of the third mask MS3. For example, in a plan view, the end of the intermediate mask M_MS1 may not overlap the end of the third mask MS3. The intermediate mask M_MS1 may be more inwardly recessed than the third mask MS3, particularly in the direction toward the end of the second mask MS2. Conversely, the third mask MS3 may protrude outwardly more than the intermediate mask M_MS1, especially in the direction facing the end of the second mask MS2.

The intermediate mask M_MS1 may have an inclined surface. For example, a side surface of the intermediate mask M_MS1 may be an inclined surface. The side surface of the intermediate mask M_MS1 may be an inclined surface with respect to a plane where the window substrate WS is arranged.

Wet-etching the window substrate using the etchant (S300) may include a step (e.g., act or task) in which the etchant flows between the etched bending area BA-1 and the third mask MS3. After the intermediate mask M_MS1 is formed, the etchant may flow into an area 10 between the etched first substrate surface WUS (for example, the bending area BA-1) and the third mask MS3. The etchant may flow into the area 10 between the first substrate surface WUS and the third mask MS3, and the intermediate mask M_MS1 may be further etched as the side surface of the intermediate mask M_MS1 and the etchant come into contact. As the intermediate mask M_MS1 is further etched, the bending area BA-1 positioned under the intermediate mask M_MS1 may be exposed to the etchant. The bending area BA-1 positioned under the intermediate mask M_MS1 may be etched by the etchant, and the bending area BA-1 may have a gentle inclination. The phrase “gentle inclination” as used herein may be a smooth and gradual inclination with a low angle of inclination, e.g., less than 5 degrees (°) or at most 1°.

The bending area BA-1 may be etched to form the bending area BA of the cover window CW. Wet-etching the window substrate using the etchant (S300) may include etching the bending area BA-1 to form the center area CTA, the first curved area CA1, and the second curved area CA2. The bending area BA-1 may be etched to form the center area CTA, the first curved area CA1, and the second curved area CA2 of the cover window CW.

The cover window CW may be etched so that the center area CTA is flat. The cover window CW may be etched so that the first curved area CA1 and the second curved area CA2 are curved. Because the first curved area CA1 and the second curved area CA2 are curved, the first curved area CA1 and the second curved area CA2 may form an angle with the flat center area CTA.

The bending area BA-1 may be etched until a thickness (that is, the second thickness T2) of the window substrate WS becomes 20 μm to 100 μm in an area overlapping (e.g., on) the center area CTA. When the second mask M2 and the third mask M3 are arranged, the first flat area A1-1 and the second flat area A2-1 of the window substrate WS may not be etched, and a thickness (that is, the first thickness T1) of the window substrate WS in the area overlapping (e.g., on) the first flat area A1-1 and the second flat area A2-1 may be 50 μm to 200 μm.

Because the first mask M1 and the second mask M2 have different etching ratios with respect to the etchant, and as M1 and M2 are arranged, the cover window CW manufactured according to the method of one or more embodiments of the present disclosure may reduce the angle between (e.g., formed by) the center area CTA and each of the first curved area CA1 and the second curved area CA2. For example, the angle between (e.g., formed by) the center area CTA and each of the first curved area CA1 and the second curved area CA2 may be at most 1° (e.g., or less). The angle between (e.g., formed by) the center area CTA and each of the first curved area CA1 and the second curved area CA2 may be an inclination angle θ.

Because the inclination angle θ is (e.g., formed to be) at most 1° (e.g., or less), an extent or risk that a boundary between the center area CTA and the first curved area CA1 and the second curved area CA2 is observed or recognized may be prevented or reduced. For example, a Kc measurement value of the first surface US of the cover window CW measured using Optimap™ (OPTIMAP) equipment may be at most 0.4 (e.g., or less). The Kc may refer to a curvature parameter value measured by a phase stepped deflectometry (PSD) method using the Optimap™ (OPTIMAP) equipment.

Referring to FIG. 12, removing the mask layer (S400) may include irradiating ultraviolet (UV) rays (e.g., light) to the mask layer MS. The ultraviolet rays (e.g., light) UV may be irradiated to the mask layer MS. The ultraviolet rays (e.g., light) UV may be irradiated to an area overlapping the third mask MS3. The ultraviolet rays (e.g., light) UV may be irradiated to the mask layer MS, and thus the mask layer MS may be removed from the window substrate WS. In other words, the mask layer may be irradiated with ultraviolet light to be removed.

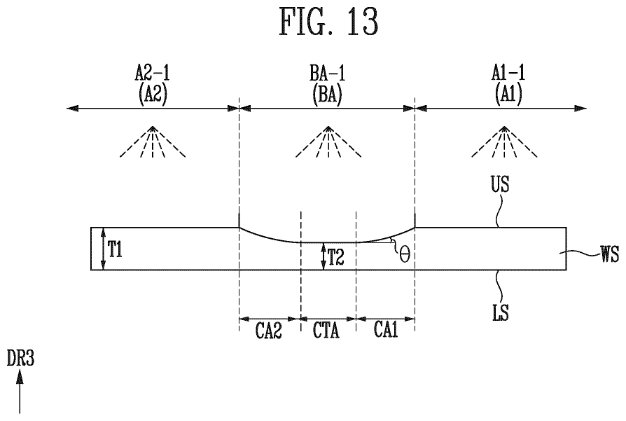

Referring to FIG. 13, according to one or more embodiments, further etching the cover window CW may be included after removing the mask layer (S400). Further etching the cover window CW may be performed after removing the mask layer (S400). According to one or more embodiments, further etching the cover window CW may not be provided.

Further etching the cover window CW may include etching the cover window CW with an etchant. For example, etching the cover window CW may include the etchant previously described elsewhere herein in more detail. The mask layer MS may be removed before further etching the cover window CW, and thus the entire area of the cover window CW may be exposed to the etchant. For example, in further etching the cover window CW, the first surface US and the second surface LS of the cover window CW may be entirely exposed to the etchant. In further etching the cover window CW, the first surface US of the cover window CW may be further etched, and an interface between the bending area BA and the first flat area A1 and the second flat area A2 may have a gentle inclination. Accordingly, a risk that a boundary between the bending area BA and the first flat area A1 and the second flat area A2 is recognized may be prevented or reduced or reduced. In other words, the method of the present disclosure may include removing the mask layer, and etching the cover window to expose a first surface of the cover window to the etchant.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

The display device, a device for manufacturing of the same, or component thereof and/or any other relevant devices or components according to embodiments of the present disclosure described herein may be implemented utilizing any suitable hardware, firmware (e.g., an application-specific integrated circuit), software, or a combination of software, firmware, and hardware. For example, one or more suitable components of the display device may be formed on one integrated circuit (IC) chip or on separate IC chips. Further, one or more suitable components of the display device may be executed by one or more computing devices to perform one or more suitable functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of one or more suitable computing devices may be combined or integrated into a single computing device, or the functionality of a particular computing device may be distributed across one or more other computing devices without departing from the scope of the embodiments of the present disclosure.

In the context of the present application and unless otherwise defined, the terms “use,” “using,” and “used” may be considered synonymous with the terms “utilize,” “utilizing,” and “utilized,” respectively.

A person of ordinary skill in the art, in view of the present disclosure in its entirety, would appreciate that each suitable feature of the one or more suitable embodiments of the present disclosure may be combined or combined with each other, partially or entirely, and may be technically interlocked and operated in one or more suitable ways, and each embodiment may be implemented independently of each other or in conjunction with each other in any suitable manner unless otherwise stated or implied.

As described herein, although the disclosure has been described with reference to one or more embodiments herein, those skilled in the art or those having a common knowledge in the art will understand that the present disclosure may be variously modified and changed without departing from the spirit and technical area of the disclosure described in the claims described in more detail elsewhere.

Therefore, the technical scope of the disclosure should not be limited to the contents described in the detailed description of the specification, but should be defined by the claims and equivalents thereof.

What is claimed is:

1. A cover window comprising:
a first surface;
a second surface opposite to the first surface;
a first flat area;
a second flat area spaced from the first flat area in one direction; and
a bending area between the first flat area and the second flat area;
wherein the first surface has a flat shape in each of the first flat area and the second flat area,
wherein the bending area comprises:
a first curved area in which the first surface extends in a curved shape from the first flat area;
a second curved area in which the first surface extends in a curved shape from the second flat area; and
a center area between the first curved area and the second curved area,
wherein the first curved area and the center area meet at a first point, an inclination angle is between a first tangent line at the first point and the first curved area, the inclination angle being at most 1°, and
wherein the cover window is for a display device.

2. The cover window according to claim 1, wherein the cover window has a thickness of 50 micrometer (μm) to 200 μm in an area on the first flat area, and has a thickness of 20 μm to 100 μm in an area on the center area.

3. The cover window according to claim 1, wherein the first surface is flat in the center area.

4. The cover window according to claim 1, wherein a Kc measurement value of the first surface is at most 0.4.

5. A method comprising:
forming a mask layer on a window substrate comprising a first substrate surface, a second substrate surface, and a third substrate surface; and
wet-etching the window substrate using an etchant,
wherein the forming of the mask layer comprises:
forming on the first substrate surface a first mask and a second mask; and
forming a third mask on the first mask and the second mask,
wherein the first substrate surface comprises:
a bending area etched during the wet-etching of the window substrate;
a first flat area on one side of the bending area; and
a second flat area on a second side of the bending area,
wherein an etching ratio of the first mask is different than an etching ratio of the second mask, and the first mask and the second mask are on one plane, and
wherein the method is a method of manufacturing a cover window for a display device.

6. The method according to claim 5, wherein the etching ratio of the first mask is different than an etching ratio of the third mask.

7. The method according to claim 5, wherein the first mask is on at least a portion of the bending area, and the etching ratio of the first mask is greater than the etching ratios of each of the second mask and the third mask.

8. The method according to claim 5, wherein the first mask is to expose at least a portion of the bending area.

9. The method according to claim 5, wherein
the second mask is to cover the first flat area, the second flat area, the second substrate surface, and the third substrate surface,
the second substrate surface is a lower surface of the window substrate, and
the third substrate surface is a side surface of the window substrate.

10. The method according to claim 5, wherein the first mask does not comprise an acid-resistant material, and the second mask and the third mask each comprise an acid-resistant material.

11. The method according to claim 5, wherein the first mask is an adhesive layer that does not comprise an acid-resistant material, or a metal layer comprising at least one selected from among titanium (Ti) and indium tin oxide (ITO),
the second mask is an adhesive layer comprising an acid-resistant material, and
the third mask is an acid-resistant film.

12. The method according to claim 5, wherein the forming of the first mask and the second mask on the first substrate surface and the forming of the third mask on the first mask and the second mask comprise:
forming a first base mask on the bending area and a second base mask on the first base mask; removing at least a portion of the first base mask and at least a portion of the second base mask; and
exposing at least a portion of the bending area.

13. The method according to claim 5, wherein the wet-etching of the window substrate comprises etching the first mask to form an intermediate mask, and
wherein an end portion of the intermediate mask is not on an end portion of the third mask.

14. The method according to claim 13, wherein the intermediate mask is recessed more than the third mask in a direction toward an end of the second mask.

15. The method according to claim 13, wherein the wet-etching of the window substrate comprises etching the bending area to provide an etched bending area and flowing the etchant between the etched bending area and the third mask.

16. The method according to claim 13, wherein the wet-etching of the window substrate comprises isotropically etching the first substrate surface.

17. The method according to claim 5, wherein the wet-etching of the window substrate comprises:
etching the bending area to form a first curved area extending in a curved shape from the first flat area and a second curved area extending in a curved shape from the second flat area; and
forming a center area between the first curved area and the second curved area, and
wherein,
the first curved area and the center area meet at a first point,
a first tangent line at the first point and the first curved area form an inclination angle, and the inclination angle is at most 1°, and
the bending area is etched to have a thickness of 20 μm to 100 μm in an area on the center area.

18. The method according to claim 5, further comprising removing the mask layer, wherein the removing of the mask layer comprises irradiating ultraviolet light to the mask layer.

19. The method according to claim 5, further comprising:
etching the cover window, wherein the etching of the cover window is performed after removing the mask layer, and comprises exposing a first surface of the cover window to the etchant.

20. An electronic device comprising a display device comprising the cover window according to claim 1.
